(19) United States
(12) Patent Application Publication
(10) Pub. No.: US 2017/0310151 A1
(43) Pub. Date: Oct. 26, 2017

(54) Suitcase Having Integrated Power Charging Device

(71) Applicants: Gennes Curescu, Skokie, IL (US); Marius Strizu, Gresham, OR (US)

(72) Inventors: Gennes Curescu, Skokie, IL (US); Marius Strizu, Gresham, OR (US)

(21) Appl. No.: 15/649,317

(22) Filed: Jul. 13, 2017

Related U.S. Application Data
(63) Continuation-in-part of application No. 14/871,470, filed on Sep. 30, 2015.

(51) Int. Cl. H02J 7/14; H02K 7/18; A45C 5/14; A45C 15/00; A45C 13/26; H02J 7/00

(52) U.S. Cl. CPC H02J 7/1423; A45C 13/262; H02K 7/1846; H02J 7/0045; A45C 5/14; A45C 15/00; H02J 2007/143; A45C 2013/267

(57) ABSTRACT

A suitcase has an integrated power charging device for integrating a power source into a suitcase in an optimal configuration. The includes a suitcase and a handle selectively extendable from the suitcase. A power module is coupled to the suitcase. A rechargeable battery is electrically coupled to a circuit board when the rechargeable battery is fully inserted into a battery compartment of the power module. A charging port on the battery is electrically coupled to the circuit board when the rechargeable battery is fully inserted into the battery compartment. A power port is positioned on the rechargeable battery exposed on the suitcase when the rechargeable battery is fully inserted into the battery compartment.

### CROSS-REFERENCE TO RELATED APPLICATIONS

This application is a continuation in part of U.S. patent application Ser. No. 14/871,470 filed Sep. 30, 2015.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to suitcases and more particularly pertains to a new suitcase for integrating a power source into a suitcase in an optimal configuration.

### BRIEF SUMMARY OF THE INVENTION

An embodiment of the disclosure meets the needs presented above by generally comprising a suitcase and a handle selectively extendable from the suitcase. A power module is coupled to the suitcase. A recharageable battery is electrically coupled to a circuit board when the rechargeable battery is fully inserted into a battery compartment of the power module. A charging port on the battery is electrically coupled to the circuit board when the rechargeable battery is fully inserted into the battery compartment. A power port is positioned on the rechargeable battery exposed on the suitcase when the rechargeable battery is fully inserted into the battery compartment.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a suitcase having integrated power charging device according to an embodiment of the disclosure.

FIG. 2 is a side view of an embodiment of the disclosure.

FIG. 3 is a rear view of an embodiment of the disclosure.

FIG. 4 is an exploded partial top front side perspective view of an embodiment of the disclosure.

FIG. 5 is an exploded partial top front side perspective view of an embodiment of the disclosure.

FIG. 6 is an exploded partial top front side perspective view of an embodiment of the disclosure.

### DETAILED DESCRIPTION OF THE INVENTION

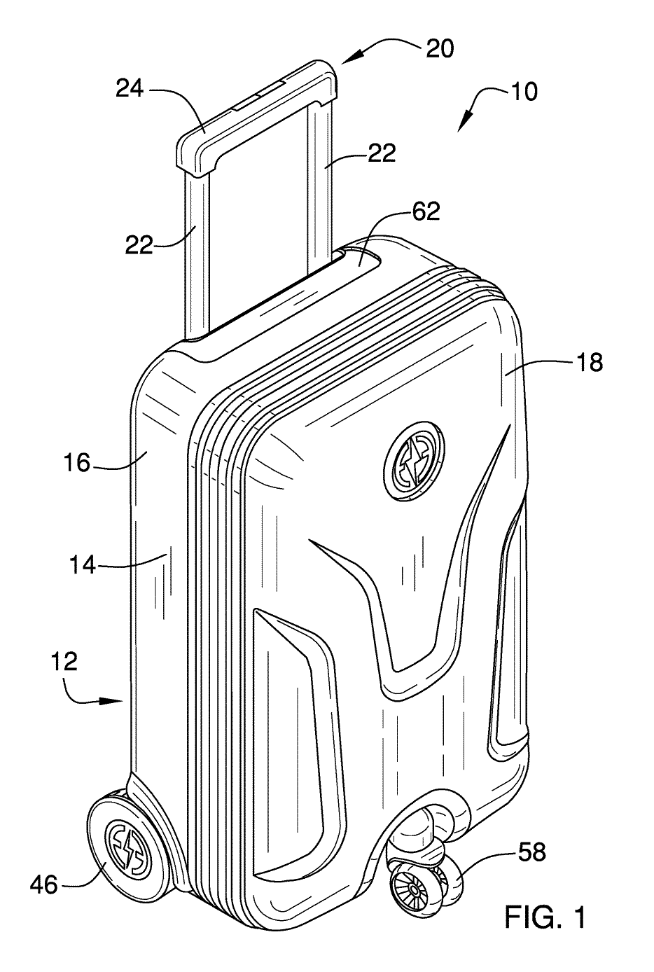

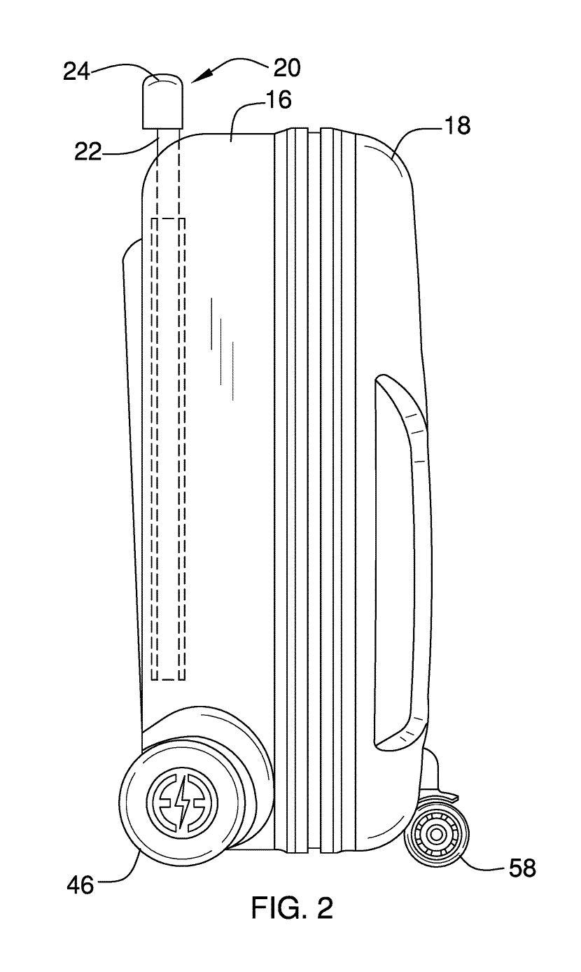

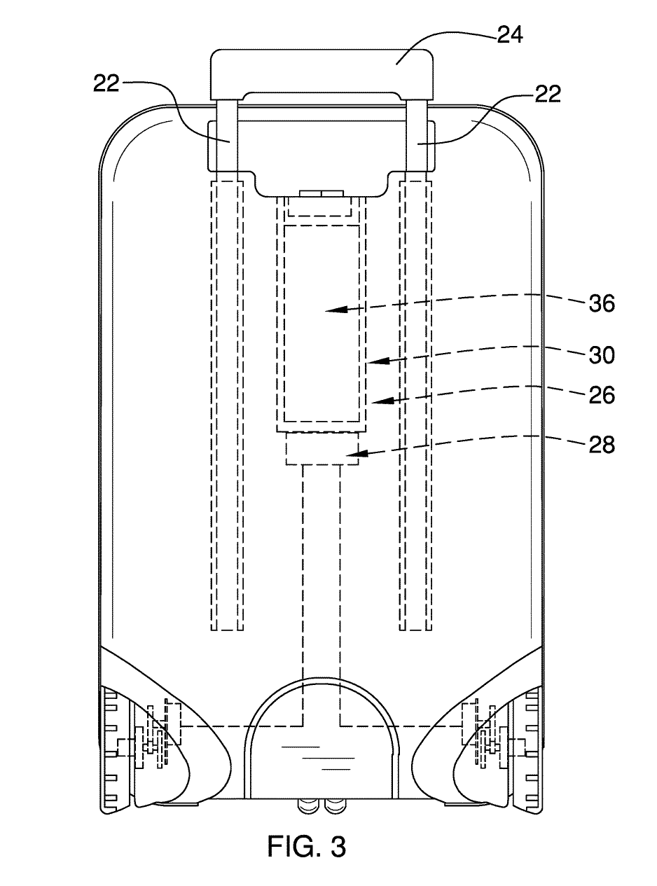

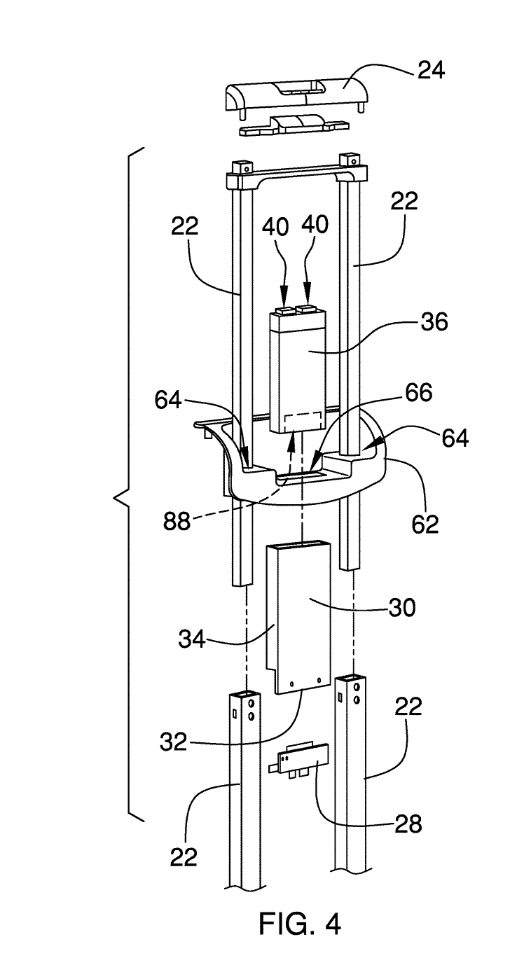

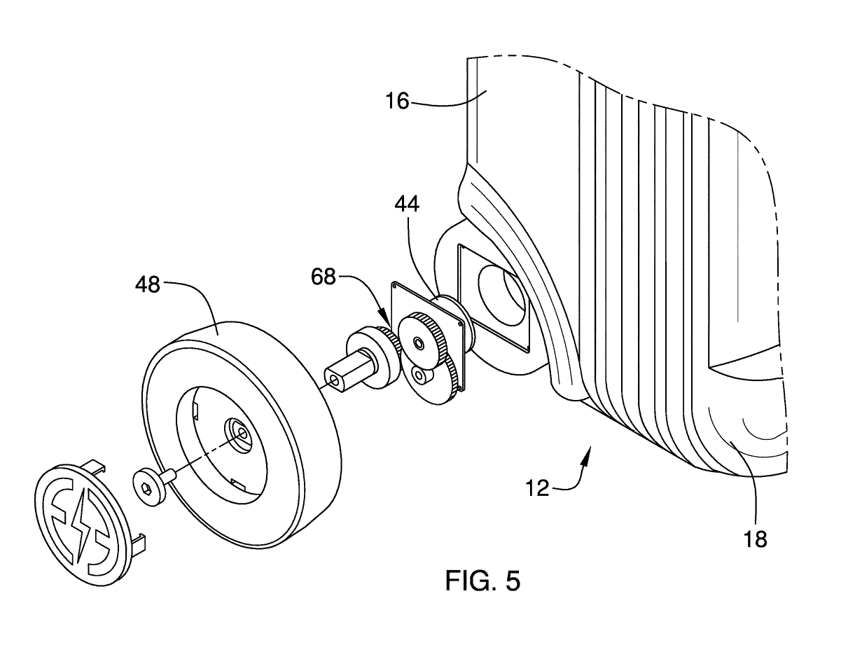

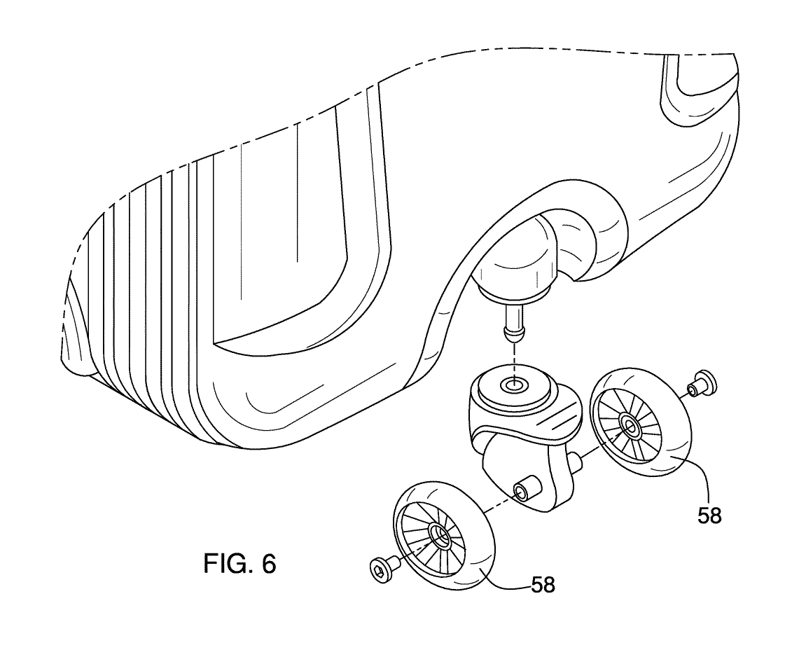

With reference now to the drawings, and in particular to FIGS. 1 through 6 thereof, a new suitcase embodying the principles and concepts of an embodiment of the disclosure and generally designated by the reference numeral 10 will be described.

As best illustrated in FIGS. 1 through 6, the suitcase having integrated power charging device 10 generally comprises a suitcase 12 comprising a housing 14 having a main section 16 and a lid 18 coupled to the main section 16. The lid 18 is pivotally coupled to the main section 16 in a conventional manner to expose an interior of the suitcase 12. A handle 20 is coupled to the suitcase 12. The handle 20 is selectively extendable from the suitcase 12 in a conventional manner. The handle 20 has a pair of uprights 22 and a grip 24 coupled to and extending between the uprights 22. The handle 20 may be provided with a conventional release button and be telescopic between a stored position and a deployed position.

A power module 26 is coupled to the suitcase 12. The power module 26 is aligned with and positioned between the uprights 22 of the handle 20. Similar to the uprights 22 while in the stored position, the power module is positioned within a chamber in the housing 14 such that the power module 26 is not exposed on the suitcase 12 nor exposed within the interior of the suitcase 12. The power module 26 includes a circuit board 28 and a battery compartment 30. The circuit board 28 may be coupled directly to a flange 32 extending from a sleeve section 34 of the battery compartment 30.

A rechargeable battery 36 is removably coupled to the battery compartment 30 by insertion through an end 38 of the sleeve section 34. A charging port 38 is positioned on the rechargeable battery 36. The charging port 36 is electrically coupled to the circuit board 28 when the rechargeable battery 36 is fully inserted into the battery compartment 30. The rechargeable battery 36 is removable from the battery compartment 30 wherein the charging port 38 is exposed and configured for coupling to an extrinsic power source for charging the rechargeable battery 36. The rechargeable battery 36 is electrically coupled to the circuit board 28 when the rechargeable battery 36 is fully inserted into the battery compartment 30.

A power port 40 is coupled to the rechargeable battery 36. The power port 40 may be of a standard or common type such as a USB, mini-USB, or other universal or proprietary type of connection commonly used when charging devices such as electronic pads, phones, music players, or the like. The power port 40 is positioned on an end 42 of the rechargeable battery 36 and may be one of a plurality of power ports 40. When a plurality of power ports 40 are provided, one or more different connection types may be utilized. The end 42 of the rechargeable battery 36 is exposed on the suitcase 12 between the uprights 22 when the rechargeable battery 36 is fully inserted into the battery compartment 30.

Each of a pair of generators 44 is coupled to the suitcase 12. Each generator 44 is electrically coupled to the power module 26 and more specifically, coupled to the circuit board 28. Each of a pair of rear wheels 46 is coupled to the suitcase 12. Each rear wheel 46 is positioned on a respective lateral side 48 of the main section 16 of the suitcase 12. Each rear wheel 46 is operationally engaged to an associated one of the generators 44 wherein rotation of the rear wheel 46 activates the generator 44 such that the generator 44 provides electrical current to the power module 26 to charge the rechargeable battery 36. Each rear wheel 46 may be coupled to the associated generator 44 by a gear assembly 68 to enhance the rotation provided to the generator 44. The rear wheels 46 are substantially coplanar with a rear surface 50 of the suitcase 12 and coplanar with the handle 20. Each rear wheel 46 has an outer face 52, an inner face 54, and a perimeter surface 56 extending between the outer face 52 and the inner face 54. The perimeter surface 56 is angled relative to an axis of rotation of the rear wheel 46 such that a circumference of the rear wheel 46 tapers from the outer face 52 to the inner face 54.

A front wheel 58 is coupled to the suitcase 12. The front wheel 58 is substantially coplanar with a front surface 60 of the suitcase 12 such that the suitcase 12 is configured for being supported on the front wheel 58 and rear wheels 46 with the handle 20 perpendicular to the support surface. The front wheel 58 may be a castor wheel such that the front wheel 58 swivels freely. The front wheel 58 may have spaced sections as shown but the spaced sections are fixed in position to allow the front wheel 58 to act as a single entity centrally positioned between the lateral sides 48 of the suitcase 12.

A mounting bracket 62 is coupled to the main section 14 of the suitcase 12. The mounting bracket 62 has a pair of spaced apertures 64. The uprights 22 of the handle 20 extend through the spaced apertures 64. The mounting bracket 62 has an opening 66 positioned between the spaced apertures 64. The rechargeable battery 36 is insertable through the opening 66 to insert the rechargeable battery 36 into the battery compartment 30. The mounting bracket 62 is rigid and reinforces the suitcase 12 around the uprights 22 and battery compartment 30. The housing 14 of the suitcase 12 may be rigid in the nature of a conventional hard shelled or hard sided travel case.

In use, the rechargeable battery 36 is positioned in the battery compartment 30 wherein the rechargeable battery 36 is charged by movement of the suitcase 12 which rotates one or both rear wheels 46. The power port 40 is accessible to allow for connection of charging cord or the like to provide electrical power to the extrinsic device as desired. The rechargeable battery 36 is also removable to allow for direct charging via a connection port 88 so the rechargeable battery 36 may be fully charged without relying solely on movement of the suitcase 12. The positioning of the power module relative to the handle 20 enhances balance and manipulation of the suitcase 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A charging device integrated suitcase assembly comprising:
a suitcase comprising a housing having a main section and a lid coupled to said main section;
a handle, said handle being coupled to said suitcase, said handle being selectively extendable from said suitcase;
a power module, said power module being coupled to said suitcase, said power module comprising a circuit board and a battery compartment;
a rechargeable battery, said rechargeable battery being removably coupled to said battery compartment, said rechargeable battery electrically coupling to said circuit board when said rechargeable battery is fully inserted into said battery compartment;
a charging port positioned on said rechargeable battery, said charging port being electrically coupled to said power circuit board when said rechargeable battery is fully inserted into said battery compartment; and
a power port coupled to said rechargeable battery, said power port being positioned on an end of said rechargeable battery, said end of said rechargeable battery being exposed on said suitcase when said rechargeable battery is fully inserted into said battery compartment.

2. The assembly of claim 1, further comprising said rechargeable battery being removable from said battery compartment wherein said charging port is exposed and configured for coupling to an extrinsic power source for charging said rechargeable battery.

3. The assembly of claim 1, further comprising:
said handle having a pair of uprights and a grip coupled to and extending between said uprights; and
said power module being aligned with and positioned between said uprights.

4. The assembly of claim 1, further comprising:
a generator, said generator being coupled to said suitcase, said generator being electrically coupled to said power module; and
a rear wheel coupled to said suitcase, said rear wheel being operationally coupled to said generator wherein rotation of said rear wheel activates said generator to provide electrical current to said power module to charge said rechargeable battery.

5. The assembly of claim 4, further comprising a gear assembly coupled to said suitcase, said gear assembly being operationally coupled between said rear wheel and said generator.

6. The assembly of claim 1, further comprising:
a pair of generators, each said generator being coupled to said suitcase, each said generator being electrically coupled to said power module; and
a pair of rear wheels, each said rear wheel being coupled to said suitcase, each said rear wheel being positioned on a respective lateral side of said main section of said suitcase, each said rear wheel being operationally engaged to an associated one of said generators wherein rotation of said rear wheel activates said generator such that said generator provides electrical current to said power module to charge said rechargeable battery.

7. The assembly of claim 6, further comprising a front wheel, said front wheel being coupled to said suitcase, said front wheel being coplanar with a front surface of said suitcase, said front wheel being a castor wheel.

8. The assembly of claim 6, further comprising said rear wheels being coplanar with a rear surface of said suitcase.

9. The assembly of claim 7, further comprising said front wheel being centrally positioned between said lateral sides of said suitcase.

10. The assembly of claim 6, further comprising each said rear wheel having an outer face, an inner face, and a perimeter surface extending between said outer face and said inner face, said perimeter surface being angled relative to an axis of rotation of said rear wheel such that a circumference of said rear wheel tapers from said outer face to said inner face.

11. The assembly of claim 3, further comprising a mounting bracket coupled to said main section of said suitcase, said mounting bracket having a pair of spaced apertures, said uprights of said handle extending through said spaced apertures.

12. The assembly of claim 11, further comprising said mounting bracket having an opening positioned between said spaced apertures, said rechargeable battery being insertable through said opening to insert said rechargeable battery into said battery compartment.

13. A charging device integrated suitcase assembly comprising:
a suitcase comprising a housing having a main section and a lid coupled to said main section;
a handle, said handle being coupled to said suitcase, said handle being selectively extendable from said suitcase, said handle having a pair of uprights and a grip coupled to and extending between said uprights;
a power module, said power module being coupled to said suitcase, said power module being aligned with and positioned between said uprights, said power module comprising a circuit board and a battery compartment;
a rechargeable battery, said rechargeable battery being removably coupled to said battery compartment, said rechargeable battery electrically coupling to said circuit board when said rechargeable battery is fully inserted into said battery compartment;
a charging port positioned on said rechargeable battery, said charging port being electrically coupled to said power circuit board when said rechargeable battery is fully inserted into said battery compartment, said rechargeable battery being removable from said battery compartment wherein said charging port is exposed and configured for coupling to an extrinsic power source for charging said rechargeable battery; and
a power port coupled to said rechargeable battery, said power port being positioned on an end of said rechargeable battery, said end of said rechargeable battery being exposed on said suitcase when said rechargeable battery is fully inserted into said battery compartment;
a pair of generators, each said generator being coupled to said suitcase, each said generator being electrically coupled to said power module;
a pair of rear wheels, each said rear wheel being coupled to said suitcase, each said rear wheel being positioned on a respective lateral side of said main section of said suitcase, each said rear wheel being operationally engaged to an associated one of said generators wherein rotation of said rear wheel activates said generator such that said generator provides electrical current to said power module to charge said rechargeable battery, said rear wheels being coplanar with a rear surface of said suitcase, each said rear wheel having an outer face, an inner face, and a perimeter surface extending between said outer face and said inner face, said perimeter surface being angled relative to an axis of rotation of said rear wheel such that a circumference of said rear wheel tapers from said outer face to said inner face;
a front wheel, said front wheel being coupled to said suitcase, said front wheel being coplanar with a front surface of said suitcase, said front wheel being a castor wheel, said front wheel being centrally positioned between said lateral sides of said suitcase; and
a mounting bracket coupled to said main section of said suitcase, said mounting bracket having a pair of spaced apertures, said uprights of said handle extending through said spaced apertures, said mounting bracket having an opening positioned between said spaced apertures, said rechargeable battery being insertable through said opening to insert said rechargeable battery into said battery compartment.
